(19) United States
(12) Patent Application Publication
(10) Pub. No.: US 2007/0184416 A1
(43) Pub. Date: Aug. 9, 2007

(54) Reference card system for interactive learning

(76) Inventors: Denise D. Kirejczyk, Pacifica, CA (US); Kevin Kirejczyk, Pacifica, CA (US)

Correspondence Address: SUNG I. OH, PROFESSIONAL LAW CORPORATION, 710 QUAIL VALLEY LANE, WEST COVINA, CA, 91791, US

(21) Appl. No.: 11/348,114

(22) Filed: Feb. 6, 2006

(51) Int. Cl. G09B 19/22

(52) U.S. Cl. 434/129

(57) ABSTRACT

A teaching aid comprises a card that is narrower than a page of a textbook, and which contains basic facts, principles, relationships, or the like which are being taught in a particular section of the textbook. A teaching method includes having the student maintain the card adjacent to a page on which questions and/or problems are presented and referring to the card as necessary to answer the questions or solve the problems being presented. The student need not transfer his or her attention from the problem or question to a task of locating the facts, principles, relationships or the like pertinent to the questions or problems being solved, which information may be located in other sections of the textbook.

### TECHNICAL FIELD OF THE INVENTION

The present invention relates to the general art of education, and to the particular field of teaching aids.

### BACKGROUND OF THE INVENTION

Beginning students, learning disabled children, and others often have difficulty with mastering the concepts and rules of certain subjects, such as mathematics, grammar, history, languages, and the like. In fact, even advanced and experienced students learning new subjects have such difficulties. Teachers are always searching for ways to present the material in an enjoyable and successful manner. Traditional methods of teaching such as memorization of multiplication tables, basic addition facts, basic subtraction facts, and division facts as well as basic rules of grammar, history facts, and the like, in many instances has been very difficult and frustrating for both the student and teacher.

It is therefore desirable to have a method of teaching and learning basic facts, rules and principles for many subjects, which is less tedious and more efficient than the traditional methods, and which is an enjoyable and efficient experience for the student. Certainly, it is desirable to have a method of teaching which will provide the teacher with an alternative to the traditional method and which will allow a successful experience for both the teacher and the student.

The inventor is aware of many methods and attempts to supplement the rote memory teaching methods. For example, card games have been used for teaching concepts and facts. Teaching machines, some of which are quite complicated and expensive, have also been used. Some teaching machines may require hand/eye co-ordination which may, in and of itself, make the teaching machine difficult and frustrating to use. Some cards are packed with so much information and are so large as to require a great deal of attention to simply locate the information of interest. This also may be difficult and frustrating. Any frustration with the teaching machine or teaching aid itself is counterproductive for both the student and the teacher.

Still further, these methods and devices have additional problems which vitiate their effectiveness. For example, these devices and methods may require a learning process in and of themselves for the teacher and/or student to learn how to use the teaching aid even before the aid can be used to teach the skill or concept. This can be wasteful and counter-productive.

Still further, some aids require the student to conduct an extensive search of the aid for the answer or guidance of interest. In fact, many textbooks have basic principles and/or facts on one page or section, and questions, problems, exposition, and discussions on other pages or sections of the book. This setup may require the student to flip back and forth through the book while working on a problem or question. In some instances, the student may have to look in an index or a table of contents to locate the information, and then turn to the designated pages, and then scan through the designated section of the text to find the information, read and understand the information, and, finally, return to the area of the text in which he or she is working. This will require the student to transfer his or her attention from the problem or question associated with teaching the principle or fact of interest to the task of finding the information in the aid. This is a distraction and may interrupt the learning process. Such interruption will certainly vitiate the efficiency of the learning process. In some cases, the process of finding the information necessary to answering a question may even overwhelm the process of answering the question. Some students may even forget the question during the process of finding the information necessary to answer the question. This, of course, is a totally undesirable situation.

To be most effective and efficient, any learning process should be uninterrupted so the student's concentration will not be interrupted. Young students, in particular, may not be able to transfer their concentration from one area to another and then back again. As can be understood from the preceding discussion, such change of focus and interruption will adversely affect the efficiency of the learning process and vitiate the advantages associated with the learning device.

Experience has shown that the most efficient method of completing any task is to remain fully focused and fully concentrating on the task being completed, and any distraction from that focus and concentration is likely to undermine the efficiency of person working on the task.

Therefore, there is a need for a learning device that can be used to display basic concepts, facts and the like in a manner that will not require a student to transfer his or her attention away from the problem of interest to a problem of using the learning device.

### SUMMARY OF THE INVENTION

The above-discussed disadvantages of the prior art are overcome by a teaching aid and method that is easy and efficient to use. The teaching aid presents facts, relationships, principles, and the like on a bookmark-like card that is stored in the book being used by a student to answer questions, solve problems or the like at a position that is immediately adjacent to the page containing the work of interest. That is, for example, the card is placed immediately adjacent to a page containing math problems. As the student works on a problem or question, the student can refer to the card without flipping back through the textbook, or re-directing his or her attention away from the problem at hand to refer to the principles or facts required to solve the problem or answer the question. In this manner, the student's attention remains focused on the problem at hand and learning is uninterrupted. This is the most efficient manner of learning.

Using the teaching aid and method of teaching embodying the present invention will permit a student to remain totally focused on the problem of interest and will thus make the learning process as efficient as possible.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view showing a plurality of teaching aids embodying the present invention.

FIG. 2 is a plan view of a teaching aid embodying the present invention.

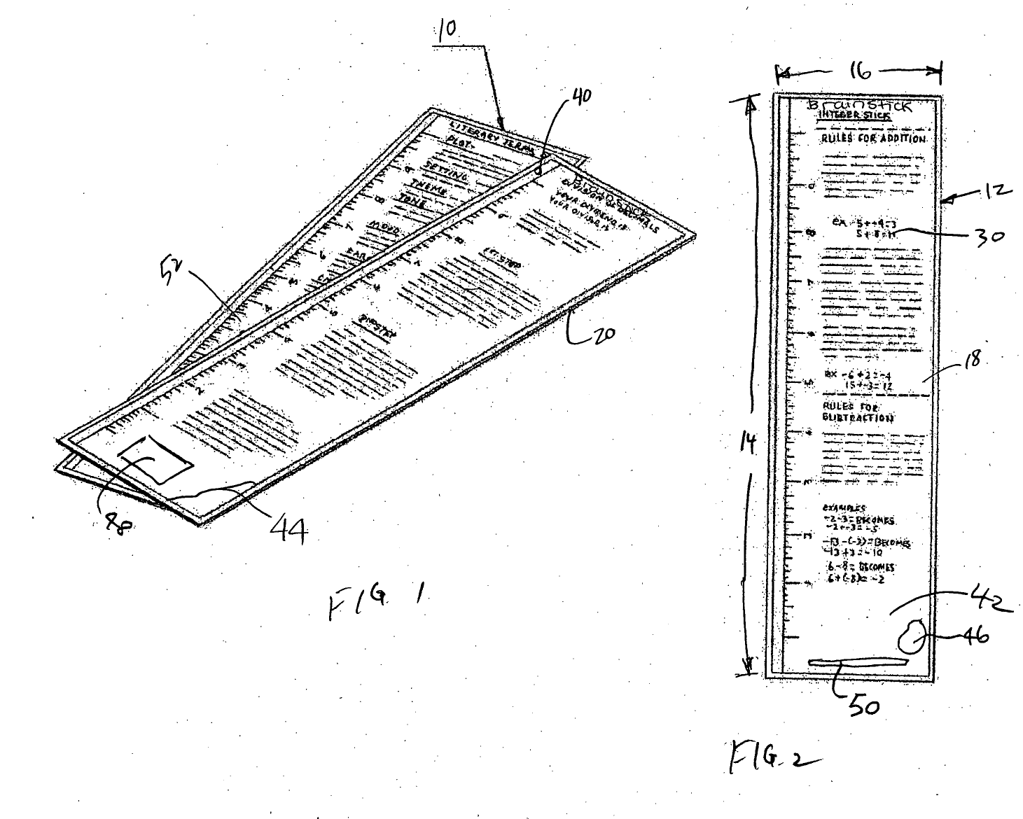

### DETAILED DESCRIPTION OF THE INVENTION

Referring to the figures, it can be understood that the present invention is embodied in a device 10 for teaching which permits a student to refer to information without diverting his or her attention away from a page containing problems or exercises intended to teach and reinforce a subject matter.

Device 10 comprises a card 12 that is in the form of a bookmark and which includes a length dimension 14, a width dimension 16, a first surface 18 and a second surface 20. Card 12 can be laminated if desired, and should be formed of material that will be strong enough to withstand repeated handling and use.

Card 12 is sized to be adapted to be interleaved between two pages of a textbook so it will be positioned for ready use by a student working on problems and questions presented on the pages of the textbook. The width dimension of the card is less than the width dimension of the pages of the book so the card will fit neatly into the book in the manner of a bookmark.

Card 12 has printed information 30 on the first surface of the card. Printed information 30 includes information associated with a subject associated with the textbook. For example, the printed information can be formulas, relationships and rules associated with a math or science subject, or it can be rules of grammar, vocabulary or the like associated with a language, or it can be facts associated with a history subject, or it can be facts relevant to art, music, literature or the like. The information on the card is the most relevant to the particular subject which is being covered in a particular section of the textbook. In some instances, a single textbook can include a plurality of cards, one for each chapter or each section of the textbook. Those skilled in the art of textbooks will understand what sort of information will be needed on the card based on the teaching of the present disclosure.

Some forms of card 12 will include rings holes, such as ring hole 40 so the card can be placed in a notebook binder, which is especially helpful for those subjects which are taught from textbooks that are in the form of notebook binders. Card 12 can also include blank areas 42 for notes, and the like which the student can place on the card so he or she can keep a record of information that is particular to their needs. Card 12 can be rectangular as shown, or it can be in various shapes, such as indicated at shape 44, which are non-polygonal or the like so the card will be appealing to young children. Card 12 can include decorations 46, including pictures or the like as well as pockets 48 for pictures or further note cards or the like. If desired, a pen 48 can be attached to the card. In addition, one side of the card 12 may be a ruler for measurement purposes.

A method of teaching using card 12 includes steps of printing information on the card,with the information being pertinent to the subject of the textbook; interleaving the card between two pages of the textbook; and referring to the information on the card to answer and solve problems presented on the pages between which the card is interleaved. The student will be ale to refer to the card to quickly find pertinent information without having to be distracted by looking elsewhere for the information and then returning back to the problem or question being answered. The concentration on the problem or question at hand is nearly total and unbroken and is thus as efficient as possible.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A device for teaching comprising:
A) a card that includes
(1) a length dimension,
(2) a width dimension,
(3) a first surface,
(4) a second surface,
(5) the card being adapted to be interleaved between two pages of a textbook, the width dimension of the card being less than the width dimension of the pages of the book; and
B) printed information on the first surface of the card, the printed information including information associated with a subject associated with the textbook.

2. The device defined in claim 1 further including blank spaces on the card, the blank spaces being sized to accept written material.

3. The device defined in claim 1 wherein the card includes at least one section that is non-polygonal in shape.

4. The device defined in claim 1 further including pockets on the card.

5. The device defined in claim 1 further including decorative indicia on the card.

6. The device defined in claim 1 further including a plurality of notebook ring-accommodating holes defined through the card.

7. The device defined in claim 1 further including ruler markings on one edge of the card.

9. The device defined in claim 1 further including rules pertaining to solving math problems.

10. The device defined in claim 1 further including rules pertaining to grammar.

11. A method of teaching comprising:
A) providing a card that includes a length dimension, a width dimension, a first surface, and a second surface;
B) sizing the card to have the width dimension less than the width dimension of a textbook;
C) printing information on the card, with the information being pertinent to the subject of the textbook;
D) interleaving the card between two pages of the textbook; and
E) referring to the information on the card to answer and solve problems presented on the pages between which the card is interleaved.

12. The method defined in claim 11 further including storing items on the card.
